(19) United States
(12) Patent Application Publication
(10) Pub. No.: US 2017/0125157 A1
(43) Pub. Date: May 4, 2017

(54) ELECTRONIC COMPONENT

(71) Applicant: Coilcraft, Incorporated, Cary, IL (US)

(72) Inventors: Scott Hess, Crystal Lake, IL (US); Kurt Smith, Crystal Lake, IL (US); Nick Darr, Lake Villa, IL (US); John Loda, Bartlett, IL (US); Jeff Finch, Cary, IL (US)

(21) Appl. No.: 15/337,282

(22) Filed: Oct. 28, 2016

Related U.S. Application Data
(60) Provisional application No. 62/248,923, filed on Oct. 30, 2015.

(51) Int. Cl. H01F 27/29; H01F 27/24; H01F 41/076; H01F 27/28

(52) U.S. Cl. CPC H01F 27/292; H01F 27/2828; H01F 27/24; H01F 41/076

(57) ABSTRACT

A surface mountable inductive component includes a miniature chip form having a main horizontal portion and supports extending therefrom, metalized pads connected to the supports for electrically connecting the chip form to a printed circuit board, and a wire wound about at least a portion of the main horizontal portion of the chip form and having first and second ends connected to respective metalized pads. The inductive component has a length to width ratio within the range of about 2.1 to about 2.5

### RELATED APPLICATION

This application claims the priority benefits of U.S. provisional application No. 62/248,923, filed on Oct. 30, 2015 and titled “Electronic Component,” which is incorporated by reference herein in its entirety.

### TECHNICAL FIELD

The present disclosure generally relates to electronic components. More specifically, the present disclosure relates to reduced size surface mountable inductive components with reduced size that perform comparably to larger components and related methods.

### BACKGROUND

The electronics industry continually aims to make products smaller and more powerful. Products such as mobile electronics devices (e.g., smart phones), portable computers, computer accessories, hand-held electronics, etc., create a demand for smaller electronic components. These products further drive technology to research new areas and ideas with respect to miniaturizing electronics.

Electronic circuits are mainly limited by the size of components used on a printed circuit board (“PCB”). That is, if the electronic components are made smaller, the circuits can be made smaller as well. Unfortunately, it can be difficult to reduce the size of certain electronic components without sacrificing something of value, such as performance or structural integrity, because the desired parameters for the component cannot be achieved when using smaller parts.

Inductive components demonstrate this size/performance trade-off well because the size of the parts used in these inductive components can readily effect many performance parameters. For example, wire gauge (the diameter of the wire) can impact both the DC resistance (DCR), the self-resonant frequency (SRF), and/or the current carrying ability of an inductive component. That is, in general, smaller or thinner wires have higher resistance, and therefore limit the effectiveness of the inductors. Accordingly, while the thinner gauged wires allow for construction of smaller components, those smaller components may be incapable of performing comparably to an original larger version of the component, (e.g., with comparable inductance, frequency range, Q-value, self-resonant frequency, or the like).

### SUMMARY

The present disclosure describes examples of a surface mountable inductive components and methods relating to the same. In some forms, the component includes a miniature chip form having a main horizontal portion and supports extending therefrom. The component also includes terminals connected to the supports for electrically connecting the chip form to a printed circuit board. A wire, in particular a 52 to 56-gauge wire, is wound about at least a portion of the main horizontal portion of the chip form and having first and second ends connected to respective terminals. In some forms the terminals are metalized pads formed on an exterior surface of the component and in others they may be formed by the ends of the wire themselves or take the shape of clips connected to the component. The inductive component has a length to width ratio within the range of about 2.1 to about 2.5, more particularly within the range of about 2.2 to about 2.4, and even more particularly about 2.4.

### BRIEF DESCRIPTION OF THE DRAWINGS

FIG. 1 is a side elevational view of an example of an electronic component according to the present disclosure.

FIG. 2A is a side elevational view of an electronic component with a cover according to examples described herein.

FIG. 2B is a bottom view of the electronic component of FIG. 2A.

FIG. 3A is a side elevational view of an electronic component with pick and place material according to examples described herein.

FIG. 3B is a bottom view of the electronic component of FIG. 3B.

FIG. 4 is a perspective view of a dogbone or dumbbell shaped core for an electronic component in accordance with examples described herein.

FIG. 5A is a perspective view of an H-shape core for an electronic component in accordance with examples described herein.

FIGS. 5B-D are front elevational, side elevational and bottom views, respectively, of the electronic component of FIG. 5A.

FIGS. 6A-B are perspective views of an electronic component and a chip form, respectively, which are known in the art as the Coilcraft® 0402 Series Chip Inductor.

### DETAILED DESCRIPTION

The present disclosure describes an inductor that is reduced in size from other inductors known in the art, while maintaining the performance capabilities and/or requirements of the existing inductors. It has been surprisingly discovered that providing an inductor that has a length to width ratio within the range of about 2.1 to about 2.5 allows the size of the inductor to be reduced, without significantly affecting performance capabilities or operating parameters such as SRF or the DCR over inductance values. In some examples, an even narrower length to width ratio range of about 2.2 to about 2.4 can yield even more desirable results. And in some situations, a length to width ratio of about 2.4 may be optimal for reducing the size of the inductor while optimizing performance parameters. In other examples, other length to width ratios may be suitable to optimize size and performance for certain applications, for example, a length to width ratio of 2.33.

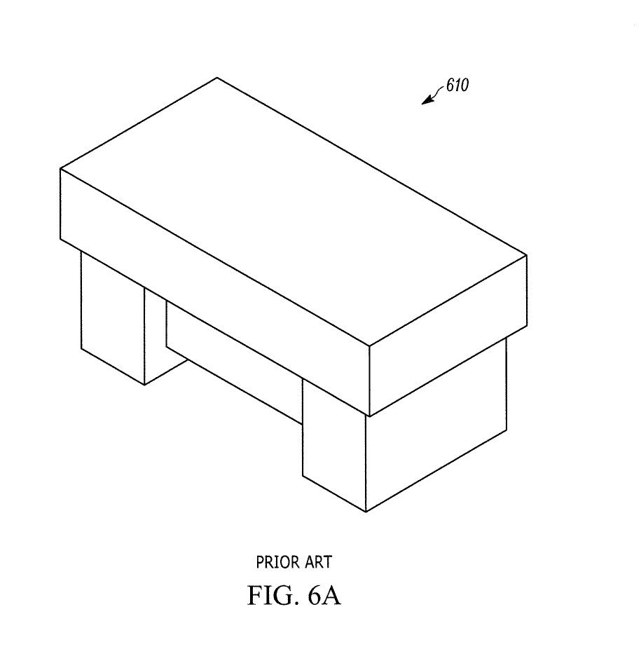

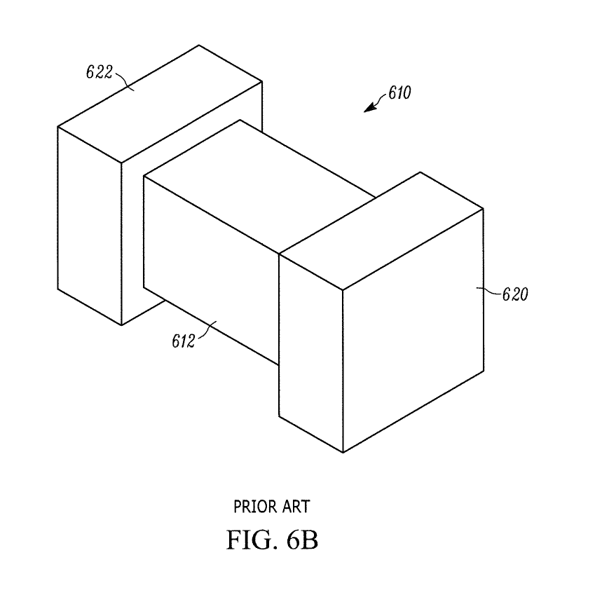

FIG. 6A shows a chip inductor 610 known in the art as the Coilcraft® 0402 Series Chip Inductor. This chip inductor has a length of 0.047 inches (or about 1.19 mm), a width of 0.025 inches (or about 0.635 mm) and a height of about 0.026 inches (or about 0.66 mm). (Note: the dimensions illustrated in the drawings are in inches.) Furthermore, as illustrated in FIG. 6B, the chip inductor has a core 612 and supports 620/622 that define a dogbone or dumbbell shaped chip form, which has a length of 0.040 inches (or about 1.02 mm), and a width and height of 0.020 inches (or about 0.51 mm). The component may be provided in inductances between 1-100 nH and with a Q-value ranging between 31-77 (at 900 MHz) or 32-100 (at 1.7 GHz). Although the performance parameters of this component are attractive, the size of the component may prevent it from being used in certain applications, such as densely populated circuits and/or products having limited space on the PCB for placing such components.

In order to maintain the 0402 Series Chip Inductor's performance parameters, the component cannot simply be reduced in size. For example, if the component's dimensions are simply reduced by 25%, the component will not be able to provide a range of inductance, frequency, Q-values, and self-resonant frequency values which are comparable to the original 0402 Series Chip Inductor. As a specific example, the component will not be able to reach the higher inductance values specified in the range of the 0402 Series Chip Inductor because the number of turns of the wire winding will be reduced due to the reduced size of the component. The inability to reach these inductance values will reduce the number of applications the component can be used in and may make the component insufficient for use in any electrical circuit. Notably, the length to width ratio of the 0402 Series Chip is about 2.0.

The present disclosure provides improved electronic components that overcome the aforementioned limitations and which further provides capabilities, features and functions that are not available in current devices. The present disclosure provides improved electronic components that are reduced in size from that of the 0402, thereby occupying less area on a PCB, while still maintaining the same, similar, or even improved performance characteristics. For example, the present disclosure provides electronic components that are reduced in size over the 0402 series chip by more than 60% (e.g., a 65% size reduction or even more), while also increasing the same or similar SRF levels of the 0402 chip, and reducing the inductance to DCR ratio exhibited by the component, each of which represents a desirable improvement.

The improved electronic components achieve these desirable results by modifying the length to width ratio of the component, making the ratio larger, from a value of about 2 (i.e., 2:1), to a value that is within the range of about 2.1 to about 2.5 (i.e., about 2.1:1 to about 2.5:1) more specifically within the range of about 2.2 to about 2.4, and even more specifically, about 2.4. It was surprisingly discovered that extending this length to width ratio of the component allowed the component to be reduced in size to greater proportions than is typically achieved with standard advancements. For example, historically, a component will reduce in size about 50-56% in a standard improvement. Here, however, size reductions of greater than 60% can be achieved without resulting in decreased performance parameters. Moreover, this increase in ratio also surprisingly resulted in a component that actually demonstrates higher SRF values, and lower inductance to DCR ratios than that of the previous component, (e.g., the 0402 Series Chip).

One example of a miniature electronic component described herein comprises a core having first and second ends with a main horizontal section extending therebetween and first and second supports for supporting the core. The first and second supports extend from respective first and second ends of the elongated core and, together with the core, define a chip form. Terminals, such as metalized pads, may be connected to the component for electrically and mechanically attaching the component to associated lands on a printed circuit board (PCB). The component further includes a wire wound about a least a portion of the main horizontal section of the core and having first and second ends which are each electrically connected to one of the terminals. As mentioned above, however, in alternate forms, the ends of the wire may be used as the terminals themselves (e.g., making it a self-leaded component) or clip type terminals may be clipped to the component.

In one form, the supports and core define a chip form having a length, width and a height. The chip form may be provided in a dogbone/dumbbell shape, or an H-shape. In some examples, the chip can be formed from a variety of materials, including but not limited to magnetic materials (e.g., ferrite), hard and soft magnetic materials, and ceramic. In some examples, the supports and core may be made from different materials, such as a ferrite core with ceramic supports. In addition, the chip form is preferably designed with a length to width ratio that is within the range of about 2.1 to about 2.5 (i.e., about 2.1:1 to about 2.5:1).

The wire winding preferably comprises a single layer of insulated wire wound about at least a portion of the core, with each winding of insulated wire making direct contact with at least a portion of the core. The wire can be, for example 54-gauge wire. In other examples, the wire can be within the range of 52-gauge to 56-gauge wire. In alternate forms, the wire may be wound in rows with only one row of wire coming into contact with the core. Although round insulated wire has been discussed thus far, it should be understood that in alternate forms other types of conductors or conductive material may be used such as flat wire, etc.

In some examples, the component may also include a cover or top portion which covers at least a portion of the wire winding. Preferably, the cover has a generally flat upper surface by which the component may be picked and placed using industry standard pick-and-place equipment. In one form, the cover is made of an acrylic material and has a generally rectangular horizontal plate structure with walls extending down from the perimeter of the plate to form a box type lid structure. It should be understood, however, that the cover may be made of alternate materials, such as non-magnetic materials (e.g., ceramics, etc.) or magnetic materials (e.g., ferrites, etc.), and may have alternate shapes, such as a flat slab extending over the top of the component or a housing extending over the entire top and sides of the component. For example, the core and cover may be made of a magnetic material, such as ferrite, to allow the component to take advantage of the magnetic properties of ferrite when used in conjunction with an inductive component. In yet other forms, the cover and winding may be molded over with such materials via injection or compression molding processes or via a casting processes. Such an over-molding does not have to be formed over the flanged ends of the component, but rather just the wire wound portion of the core if it is desired to shield the coil without increasing the overall height of the component.

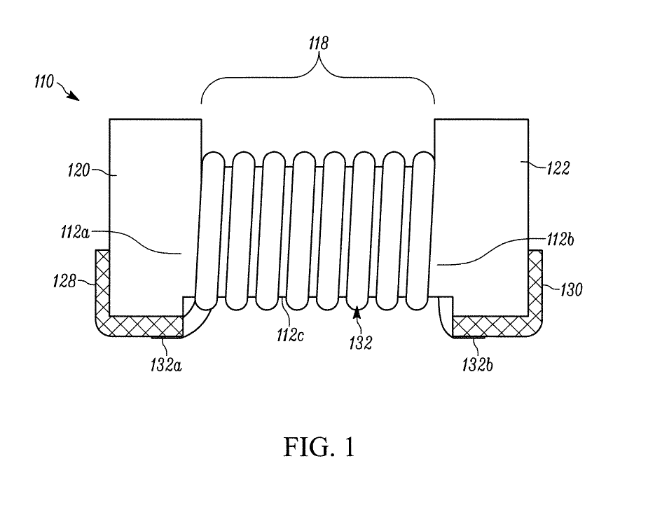

FIG. 1 shows an example of an electronic component 110 comprising a low profile chip inductor having a generally rectangular shaped core 112 having first and second ends 112a and 112b with a main horizontal section 112c extending therebetween. The rectangular shape of the core 112 assists in maintaining the low profile of the component 110. For example, a round core of same or similar volume to the rectangular core shown would add height to the component, thereby making it less desirable in applications with strict height limitations. First and second supports 120 and 122 are connected to the core 112 and are preferably integral therewith. In the embodiment illustrated in FIG. 1, the core 112 and supports 120 and 122 can be formed from a solid piece of ceramic, but it should be understood that other materials that are suitable for forming such cores (e.g., powdered metal) could also be used.

It should also be understood that in alternate embodiments the supports 120 and 122 may be separate structures to strengthen the component 110 and/or allow for the supports and core to be made from different materials. For example, in an alternate embodiment, the supports 120 and 122 may be in the form of ceramic receptacles within which a ferrite core 112 is disposed, as disclosed in U.S. Pat. No. 6,690,255 B2 issued Feb. 10, 2004, which is hereby incorporated herein by reference in its entirety. This design allows the component 110 to take advantage of the magnetic properties of ferrite and the structural strength of ceramic, thereby increasing the magnetic flux density of the component and strengthening the component's ability to absorb and/or withstand mechanical forces experienced by the component 110. Alternatively, the supports may be connected to form a base to which the core 112 is connected. For example, the supports may form a ceramic base upon which a ferrite core is rested, as is disclosed in U.S. Pat. No. 6,717,500 B2 issued Apr. 6, 2004, which is hereby incorporated herein by reference in its entirety.

As illustrated in FIG. 1, the supports 120 and 122 have respective metalized pads 128 and 130 which are used to electrically and mechanically connect the components to corresponding lands on a PCB via solder. In this way, the component can be added into a circuit located on a PCB. The metalized pads 128 and 130 are preferably bonded to the supports and L-shaped in order to strengthen the coupling between the metalized pad and the support and in order to strengthen the solder connection created between the component and the lands on the PCB. More particularly, the L-shaped metalized pads increase the amount of surface area connecting the pads to the supports and the pads to the PCB lands. This increase in surface area results in a stronger coupling between these portions of the component and the PCB. Similar benefits are achieved by making the metalized pads 128 and 130 cover the entire bottom surface of the supports 120 and 122, rather than covering only a portion of these surfaces.

In alternate embodiments, the metalized pads 128 and 130 may be provided in different shapes and sizes. For example, in one form, the pads may be generally U-shaped pads extending over the bottom and side surfaces of the supports 120 and 122. Such a configuration can strengthen the connection between the metalized pads 128 and 130 and the supports 120 and 122, and the connection between the component 110 and the corresponding lands located on the PCB once the component is soldered thereto. For example, the additional sidewall portions of the pad increase the amount of surface area connecting the metalized pads to the supports thereby increasing the strength between the pads and the supports. Similarly, the metalized pads contain more surface area which can be soldered to the corresponding lands on the PCB, thereby increasing the mechanical strength of the connection between these two items.

In yet other forms, the metalized pads 128 and 130 may be formed like clips which are pressed onto the component. For example, the pads may be generally U-shaped or C-shaped clips which are pressed over the ends of the supports 120 and 122 (e.g., if U-shaped) or over the sides and top & bottom of the core or component (e.g., if C-shaped). More particularly, the clips may be press fit or frictionally fit onto the supports 120 and 122, or may be fixed thereto by an adhesive, or both. In other forms, the metalized pads 128 and 130 may simple comprise metal coatings applied to the bottom surfaces of the supports 120 and 122. In still other forms, the wire ends may form the terminals or solder pads as discussed above (e.g., self-leading).

As illustrated in FIG. 1, the electronic component 110 also includes a wire 132 wound about at least a portion of the main horizontal section 118 of the core 112. In the embodiment shown, the wire 132 is made from an electrically conductive material such as copper and has first and second ends 132a and 132b which are electrically connected to the metalized pads 128 and 130 so that the component can be electrically connected to a circuit on the PCB when soldered thereto. More particularly, the first end 132a is connected to metalized pad 128 and the second end 132b is connected to metalized pad 130. Both ends 132a and 132b are flattened or pressed so as to minimize the amount each sticks out from the bottom of the metalized pads 128 and 130. This minimizes the amount metalized pads 128 and 130 will be raised from the corresponding lands on the PCB and helps ensure that both the wire ends 132a and 132b and the pads 128 and 130 will be coated with solder when the component is soldered to the PCB. Further, the flattened ends 132a and 132b allow the component 110 to rest more squarely on the PCB making placement of the component easier. As noted above, the wire 132 can take various sizes, or diameters. For example, in one embodiment, the wire 32 can be 52 gauge through 56-gauge wire. In some embodiments, depending on the configuration and shape of the component, it has been found that 54-gauge wire can result in an optimally performing, reduced-size component.

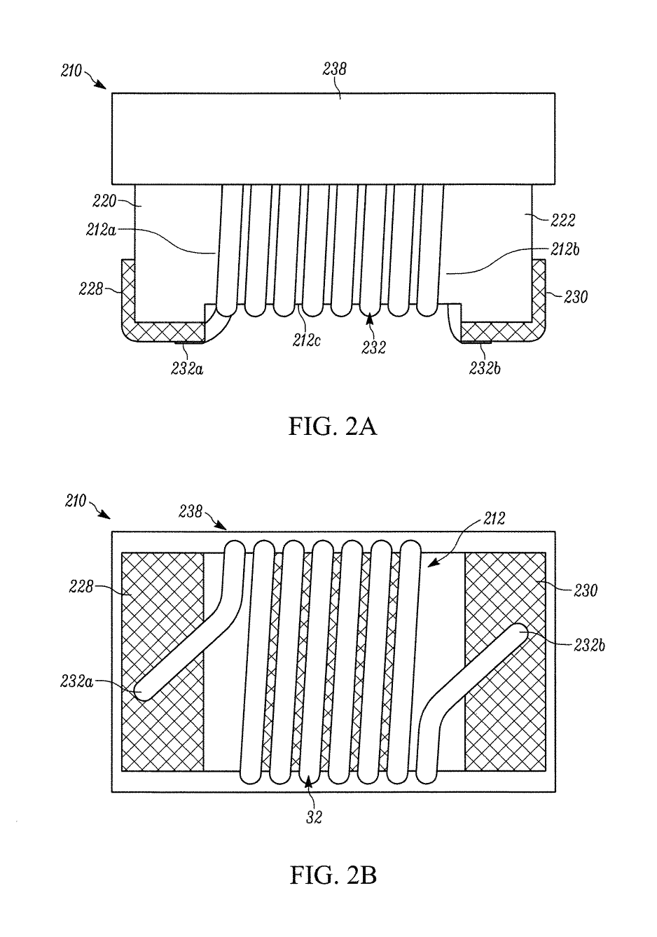

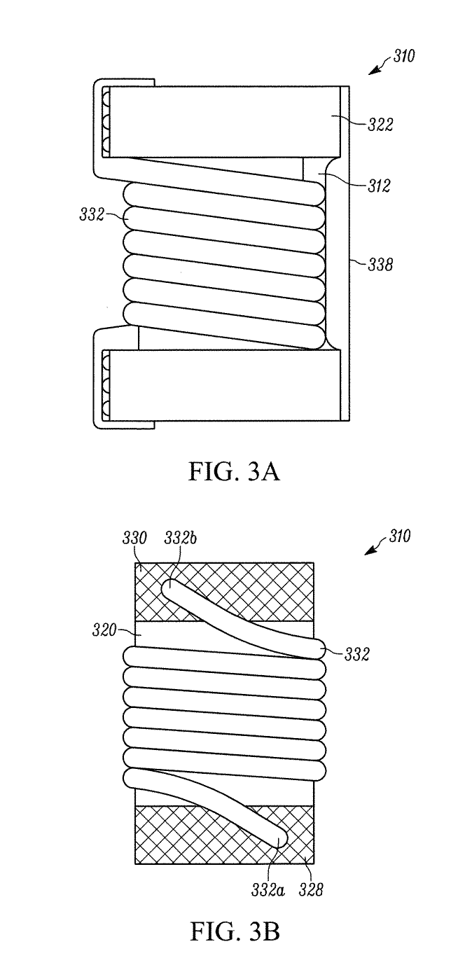

FIGS. 2A-3B show alternative configurations of the component 110 of FIG. 1. For convenience throughout this application, items which are similar among the various figures that relate to, correspond to, or are similar to one another will be identified using the same two-digit suffix as a reference numeral in combination with a prefix that is consistent with the Figure number to distinguish one embodiment from the other. For example, FIGS. 2A-B and 3A-B show embodiments of an electronic component corresponds to the electronic component 110 shown in FIG. 1, but is referenced as item number 210 and 310, respectively. It should be appreciated that where a statement is made regarding a component with respect to a specific figure or embodiment (e.g., component 110), that description can also be applied to other components bearing the same two-digit suffix in other figures, unless the context clearly dictates otherwise.

As shown in FIGS. 2A-B, the electronic component 110 may also have a top portion or cover 138 connected to the component for providing a flattened surface with which the component can be picked up using industry standard component placement equipment, such as pick-and-place machines. Such a top portion 138 allows the component 110 to be packaged in tape and reel packaging which is widely used and preferred by purchasers of electronic components.

In the embodiment shown in FIGS. 2A-B, the top portion 238 is generally rectangular in shape with outer side walls extending downward therefrom. Such a configuration allows the top portion 238 to operate as a cover over at least a portion of the wire wound core 212, and preferably over the core 212, supports 220 and 222, and wire 232. A cover extending over the entire chip form and wire also provides the added protection of covering the current carrying wire 232 so that it cannot be inadvertently touched or shorted while carrying current.

In one form, the top portion 238 is made of an acrylic and provides a large generally flat top surface for vacuum pick-and-place equipment to acquire and remove the component from a reel and place the packaged component 210 on a PCB. In alternate forms, however, the top portion 210 may be made of a magnetic material, such as ferrite, to further enhance the performance of the component 10. A ferrite top portion will significantly increase the inductance of the component 210 and lower its leakage inductance, as is discussed further in U.S. Pat. No. 6,717,500 B2 which has been incorporated herein by reference.

In some examples, the electronic component may include pick and place material as the cover, or in place of it. FIGS. 3A-B show an example of a component 310 that uses pick and place material 338, which can be a label, for example. The pick and place material 338 is connected to the component 310 and provides a flattened surface with which the component 310 can be readily picked up using industry standard component placement equipment, such as pick-and-place machines. As noted, the pick and place material 338 can be as a label, and can be formed from a material such as plastic (or other polymer) paper, or other like materials.

The components described herein can be used in a variety of applications and can even be designed for application specific uses. More particularly, the actual materials used for the various parts of the component, (e.g., the core 112, supports 120 and 122, wire 132 and cover 238/338), may be selected specifically for the particular application for which the component will be used. For example, in applications requiring a more sensitive coil 132, a core material having a higher permeability will be used. The higher the permeability of the material is, the higher the inductance of the component will be and the more sensitive the coil will be, albeit operating at a lower frequency. Alternatively, if the application calls for the component to operate at a higher frequency or with a less sensitive coil, materials with lower permeability values may be selected.

As noted, the relationships and aspect ratios between the various dimensions of the electronic component play a role in allowing the component to be miniaturized at a level greater than expected, without resulting in a significant decrease in performance, and even resulting in an improved performance in many forms. In one example, a component has a length of about 0.030 inches (0.76 mm), a width of about 0.013 inches (about 0.33 mm), and a height of about 0.022 inches (about 0.56 mm). Submitted along with U.S. provisional application No. 62/248,923 was submitted along with a product data sheet that includes further specifications and information regarding one or more examples of such an electronic component. U.S. provisional application No. 62/248,923, including the associated Figures and information in the aforementioned product data sheet are hereby incorporated by reference in its entirety. These configurations will allow the component to provide inductances and Q-values which are comparable to or even greater than those provided by larger components such as the Coilcraft® 0402 Chip Inductor, while offering a significantly reduced component size. The exact dimensions selected and number of windings of wire 132 will determine the overall components performance parameters. For example, smaller length dimensions and/or more compressed windings of wire will force the wire 132 to form more circular or ring-shaped coils, rather than elongated spiral coils. This will increase the magnetic flux density of the component, which in turn, increases the Inductance and Reactance of the component. More particularly, the Reactance of the component may be determined by the equation:

Reactance=2π×Frequency×Inductance

Thus, the additional windings will increase the Inductance and, in turn, increase the Reactance of the component. The Q-value of the component may be determined by the equation:

$$Q = \frac{REACTANCE}{RESISTANCE}$$

Therefore, the increase in reactance will also result in an increase in the Q-value of the component, assuming the resistance of the component will be maintained or lowered. In the embodiment illustrated herein (and discussed further below), the spacing of the wire windings may also be altered to further vary the inductance of the component, if desired.

The following discusses specific examples of embodiments which produce components having performance factors (e.g., DCR, SRF, inductances, Q-values, etc.) that are comparable to larger chip inductors, such as the Coilcraft® 0402 Chip Inductor. It should be understood, however, that these embodiments are merely examples of components made in accordance with the invention and should not be interpreted as the only embodiments to which the invention applies.

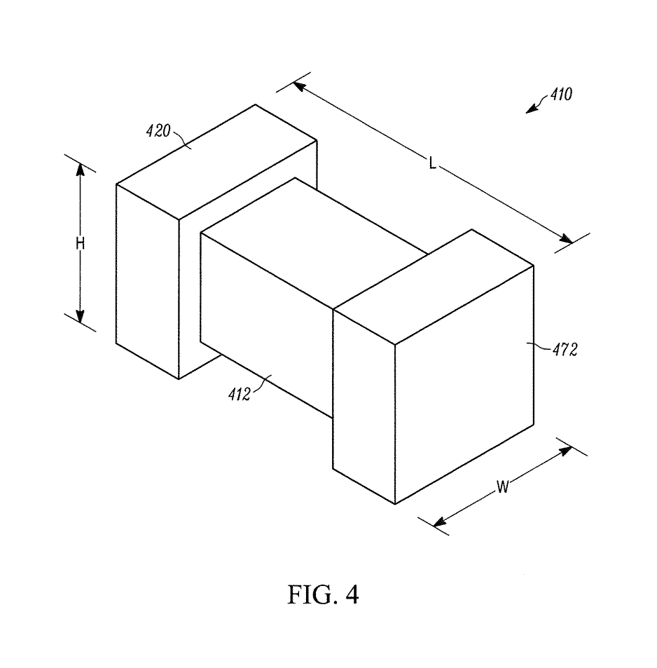

FIG. 4 shows an example of an electronic component 410 formed in a dogbone or dumbbell shaped configuration. The component 410 comprises a core 410 placed between two supports 420 and 422. As depicted, the core 410 has a narrower dimension in both height and width than that of the supports 420 and 422. FIG. 4 also the component 410 with relative dimensions identified as length (“L”), width (“W”) and height (“H”) for reference. The present disclosure makes reference to particular aspect ratios, which refers to the length to width ratios of the components. This can be reflected as the ratio of L/W based on the figures presented herein. As discussed above, it was surprisingly found that forming an electronic component having an aspect ratio (L/W) within the range of about 2.1 to about 2.5 allowed the component to be successfully miniaturized without resulting in a significant decrease in performance compared to that of the 0402 Chip Inductor of FIGS. 7A-B. For instance, the aspect ratio of the prior art 0402 Chip inductor of FIGS. 7A-B is:

$$Aspect Ratio = \frac{Length}{Width} = \frac{{0.040}^{″}}{{0.02}^{″}} = 2.0$$

It was found that simply reducing the size of the dimensions of the 0402 Chip Inductor in equal proportions did not result in a suitable miniaturized component. That is, maintaining the 2.0 aspect ratio of the 0402 Chip Inductor did not produce optimal results in a miniaturized component. However, it was surprisingly found that the component size could be significantly while still producing a range of comparable DCR, SRF, inductance, and Q-values equivalent or even superior to that of larger components if the aspect ratio was modified to be within the range of about 2.1 to about 2.5, more particularly within about 2.2 to about 2.4, and even more specifically to about 2.4.

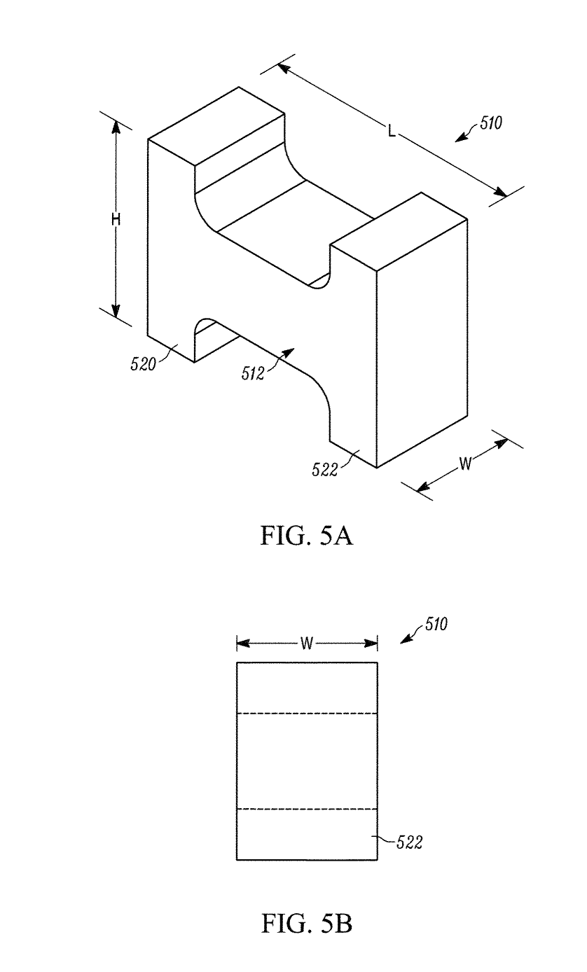

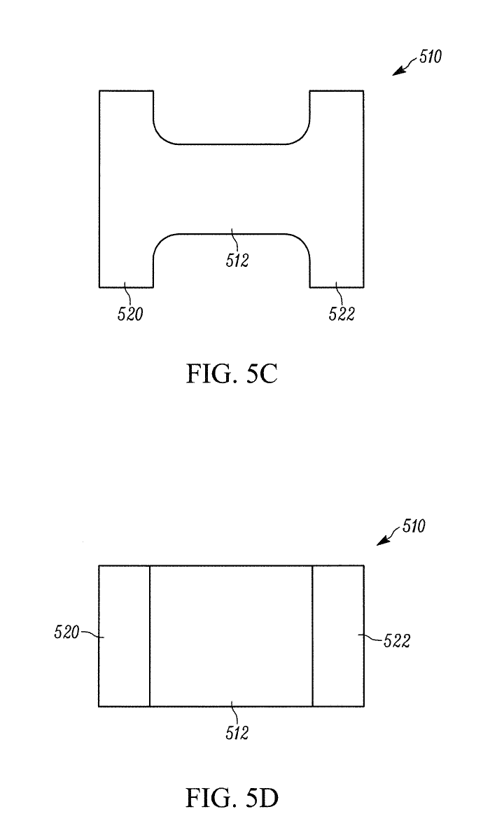

As noted above, FIG. 4 shows a component 410 with the dimensions of height (H), length (L) and width (W) of a dogbone-type chip with respect to the component. FIGS. 5A-D shows an example of a component 510 formed in an H-shaped configuration. In this format, the core 512 has a smaller height than that of the supports 520 and 522, but the width is generally the same such that the H-shaped component 510 forms a generally flat or planar surface on at least two sides of the component 512. The core 512 the component 510 of maintains the same width as the supports 520 and 522, rather than decreasing in size to form a dogbone or dumbbell shape chip form as illustrated in FIG. 4.

FIG. 5A is a perspective view of the H-shaped component 510 and shows the component 510 relative to the various dimensions of height (H), length (L), and width (W). FIGS. 5B-D provide perspective, front elevational, side elevational and bottom views, respectively, of the H-shaped component 510. The dimensions shown and discussed are relative to the inductive component 510 itself, and the aspect rations described herein, including the ranges suited to optimize the miniaturization of the component (e.g., aspect ratios within a range of about 2.1 to about 2.5) refer to the dimensions of the inductive component. However, it should be appreciated that in some embodiments, the chip form itself, that is, the portion of the component that connects to the terminals, may also have dimensions configured to be within these ranges (i.e., aspect ratios within about 2.1 to about 2.5). For example, in some examples, the chip form itself may have a length to width ratio within the range of about 2.1 to about 2.5, such as about 2.2, or about 2.4.

As described herein, it has been surprisingly discovered that manipulating these dimensions so that the electronic component has a certain length to width ratio allows the component to be reduced in size, without significantly negatively impacting the performance of the component, and in some situations, even allowing the performance parameters to improve. In some examples, the component 510 can have a length of about 0.026″ (about 0.66 mm) and a width of about 0.011″(about 0.28 mm), forming an aspect ratio of about 2.4, and a board area of about 0.000286 in² (about 0.18 mm²).

In developing the presently described improved electronic components, there was an objective to provide an inductor having an inductance value in the range of 400-600 nH, that produced an SRF value greater than 1 GHz, while having a component width less than about 0.014? (about 0.36 mm), or otherwise reducing the board area size of the 0402 Series Chip by at least 60%. Because the 0402 Series Chip exhibits a board area of about 0.00081 in² (about 0.52 mm²), the objective was to produce components that were smaller than 0.00033 in² (about 0.21 mm²) in board area, representing a 60% reduction from 0.00081 in² (or 0.52 mm²).

TABLE 1

| | Inductance | | | | | | Length/ | | |
|---|---|---|---|---|---|---|---|---|---|
| Component | (L) | DCR | SRF | Board Area | | L/DCR | Width | SRF/Length | |
| 0402 | 560 nH | 1.02 W | 1.2 GHz | 0.00081 | in² | 550 nH/Ω | 2.00:1 | 0.047 | GHz/in |
| | | | | (0.52 | mm²) | | | (1.2:1 | GHz/mm) |
| 0201 | 560 nH | 2.20 W | 0.5 GHz | 0.00022 | in² | 255 nH/Ω | 1.70:1 | 0.020 | GHz/in |
| | | | | (0.14 | mm²) | | | (0.5:1 | GHz/mm) |
| Sample 1 | 560 nH | 3.70 W | 1.7 GHz | 0.00026 | in² | 150 nH/Ω | 2.14:1 | 0.118 | GHz/in |
| | | | | (0.17 | mm²) | | | (3.0:1 | GHz/mm) |
| Sample 2 | 560 nH | 2.30 W | 1.6 GHz | 0.00028 | in² | 240 nH/Ω | 2.40:1 | 0.094 | GHz/in |
| | | | | (0.18 | mm²) | | | (2.4:1 | GHz/mm) |
| Sample 3 | 560 nH | 1.85 W | 1.5 GHz | 0.00031 | in² | 300 nH/Ω | 2.50:1 | 0.083 | GHz/in |
| | | | | (0.20 | mm²) | | | (2.1:1 | GHz/mm) |
| Sample 4 | 560 nH | 1.10 W | 1.0 GHz | 0.00039 | in² | 510 nH/Ω | 3.25:1 | 0.043 | GHz/in |
| | | | | (0.25 | mm²) | | | (1.1:1 | GHz/mm) |

Table 1 demonstrates the performance value of various electronic components tested with these objectives in mind. More specifically, Table 1 depicts various parameters and values of 6 different electronic components having an inductance of 560 nH tested against one another. The first two components, identified in Table 1 as 0402 and 0201 represent prior art components. The 0402 component represents the prior art 0402 Series Chip discussed herein, against which the size reduction is measured. As the name indicates, the 0402 component has a length of 40 mils (or 0.040″) and a width of 20 mils (or 0.020″), thereby resulting in a length to width ratio of 2.0. As seen in the table, this product has an SRF of 1.2 GHz, greater than the 1.0 GHz threshold, but has a board area of 0.00081 in² (about 0.52 mm²). The second prior art component relates to a Coilcraft® 0201 component, which has a length to width ratio of 1.70 to 1. This component significantly reduced the board area size to 0.00022 in² (about 0.144 mm²), but was unable to achieve the goal of 1.0 GHz SRF value.

On the other end of the spectrum, test sample 4 was a component having a length to width ratio of 3.25. While this component was able to meet the 1.0 GHz SRF value, the board area was only reduced to 0.00039 in² (about 0.25 mm²), which, while still represents a size drop of more than 50% from the 0402 Series Chip, was not enough to meet the 60% size drop objective.

To meet these objectives of 1 GHz SRF for inductance values in the 400-600 nH range, it was surprisingly discovered that modifying the length to width ratio of the component to within the range of about 2.1 to about 2.5 allowed these results to be achieved. As Table 1 demonstrates, Samples 1, 2, and 3 each represent electronic components that exhibit a size drop of more than 60%, while also being capable of meeting the 1.0 GHz minimum SRF objectives. Each of these components are produced with a length to width ratio within the range of about 2.1 to about 2.4. Of these three samples, Sample 1 resulted in the smallest component, with a board area of 0.00026 in² (about 0.17 mm²), and the highest SRF value of 1.7 GHz, however, the inductance to DCR ratio of 150 nH/Ω (a property that is desirably high) was lower than that of Samples 2 and 3. Sample 2 represents a component with size and SRF values very similar to those of Sample 1 (0.00028 in² or about 0.18 mm² and 1.6 GHz, respectively), with an inductance to DCR ratio of 240 nH/Ω, significantly higher than that of Sample 1. Accordingly, in some examples, electronic components having a length to width ratio within the range of about 2.2 to 2.4, and more specifically of about 2.4 will optimize the size and performance properties of the component.

The presently disclosure provides examples of a surface mountable inductive component. The component includes a miniature chip form having a main horizontal portion and supports extending therefrom. Some examples also include pads, including, for example, metalized pads connected to the supports for electrically connecting the chip form to a printed circuit board. A wire wound about at least a portion of the main horizontal portion of the chip form. The wire can be, for example 52 gauge to 56-gauge wire (e.g., 54-gauge wire). The wire has first and second ends connected to respective pads. The inductive component has a length to width ratio within the range of about 2.1 to about 2.5. In some examples, the inductive component has a length to width ratio within the range of about 2.2 to about 2.4. In still further examples, the inductive component has a length to width ratio of about 2.4.

The inductive component may include a core in some examples. The inductive component and/or the core may include a ferrite material. The inductive component and/or the core can also include at least one of a dogbone, dumbbell, or H-shaped configuration.

The functional and performance properties of the described inductive components may be similar to, or even better than that of previous products that have a larger size. In some instances, the inductive components have an inductance within the range of about 400 nH to about 600 nH, and more specifically, an inductance of about 560 nH. The inductive component may also exhibit an SRF greater than 1 GHz. In some examples, the component exhibits an SRF at least about 1.2 GHz, at least about 1.5 GHz, at least about 1.6 GHz, or at least about 1.7 GHz. Further, some examples of the inductive components may also be able to exhibit an inductance to DCR ratio no greater than about 550 nH/Ω. In other examples, the inductive component exhibits an inductance to DCR ratio no greater than about 510 nH/Ω, about 300 nH/Ω, about 240 nH/Ω, or about 150 nH/Ω.

The inductive component can have a width less than about 0.014″ (about 0.36 mm). Some examples of the inductive component will have a board area of less or equal to than about 0.000388 in² (about 0.25 mm²). In some examples, the inductive component will have an area less than or equal to about 0.00033 in² (about 0.21 mm²), or 60% smaller than that of the 0402 Series Chip, which has an area of about 0.0806 in² (about 0.52 mm²). In still other examples, the inductive component will have a board area of less than or equal to about 0.00031 in² (about 0.20 mm²), less than or equal to about 0.00028 in² (about 0.18 mm²), or less than or equal to about 0.00026 in² (about 0.17 mm²). Certain examples of the inductive component have a length to width ratio of about 2.4 to 1, a board area of about 0.00028 in² (about 0.18 mm²), an SRF value of about 1.6 GHz, an inductance to DCR ratio of about 240 nH/Ω, and an SRF/length ratio of about 2.4:1 GHz/mm.

The electronic component can employ wire within the range of 52-gauge to 56 gauge. For example, the electronic component can employ 54-gauge wire. The electronic component can be formed from, or comprise a variety of materials, including magnetic material, such as hard and soft magnetic material, and/or ferrite.

The presently described electronic components can be used in a variety of devices, including, for example, mobile electronic devices such as smart phones or wrist-worn mobile electronic devices (e.g., smart watches).

The present disclosure also presents methods of forming an electronic component. An example of one method includes providing a core and/or an electronic component. For example, the providing can include presenting any of the cores and/or components described herein. The core/component has a narrowed portion (e.g., a reduced diameter/width portion) upon which wire may be wound. For example, the core/component may be a dogbone or dumbbell configuration with a narrowed central portion, or it may have an H-shaped configuration that has a narrow portion in the center of the component. The core/component has a length to width ratio within the range of about 2.1 to about 2.5. Wire is then wound around the component, in particular, around the narrowed portion. The wire can be of various sizes, and in some forms can be a 54-gauge wire or other wire within the range of 52-gauge to 56-gauge. The wire has first and second ends. The method further includes either connecting the first and second ends of the wire to terminals, or forming terminals from the first and second ends for mounting the electronic component to a circuit. The method may further include mounting the electronic component to a circuit via the terminals formed from or connected to the first and second ends of the wire.

The first and second of the wire can be embedded in metalizing thick film to form terminals so that a strong electrical connection will be made between the component and a PCB when the component is soldered to the PCB via conventional soldering techniques. In alternate embodiments, however, the wire ends may be connected to the terminals of or other pads of the component using other conventional methods, such as by staking or welding them to the terminals.

The present disclosure describes preferred embodiments and examples of the present technology. Those skilled in the art will recognize that a wide variety of modifications, alterations, and combinations can be made with respect to the above described embodiments without departing from the scope of the invention as set forth in the claims, and that such modifications, alterations, and combinations are to be viewed as being within the ambit of the inventive concept. In addition, it should also be understood that features of one embodiment may be combined with features of other embodiments to provide yet other embodiments as desired. All references cited in the present disclosure are hereby incorporated by reference in their entirety.

1) A surface mountable inductive component comprising:
a miniature chip form having a main horizontal portion and supports extending therefrom;
terminals connected to the supports for electrically connecting the chip form to a printed circuit board; and
a wire wound about at least a portion of the main horizontal portion of the chip form and having first and second ends that form the terminals or are connected to respective terminals,
wherein the inductive component has a length to width ratio within the range of about 2.1 to about 2.5.

2) The inductive component of claim 1, wherein the inductive component has a length to width ratio within the range of about 2.2 to about 2.4.

3) The inductive component of claim 2, wherein the inductive component has a length to width ratio of about 2.4.

4) The inductive component of claim 1 further comprising a core, wherein at least one of the electronic component and the core comprises a ferrite material.

5) The inductive component of claim 5, wherein at least one of the electronic component and the core comprises at least one of a dogbone, dumbbell, or H-shaped configuration.

6) The inductive component of claim 1, wherein the inductive component exhibits an inductance within the range of about 400 nH to about 600 nH.

7) The inductive component of claim 6, wherein the inductive component exhibits inductance of about 560 nH.

8) The inductive component of claim 1, wherein the component exhibits an SRF at least about 1.7 GHz.

9) The inductive component of claim 1, wherein the component exhibits an inductance to DCR ratio no greater than about 150 nH/Ω.

10) The inductive component of claim 1, wherein the component has a width less than about 0.014 inches.

11) The inductive component of claim 1, wherein the component has an area of less than about 0.00039 in².

12) The inductive component of claim 1, wherein the component has an area less than about 0.00026 in².

13) The inductive component of claim 1, wherein the inductive component has a length to width ratio of about 2.4, a board area of about 0.00028 in², an SRF value of about 1.6 GHz, an inductance to DCR ratio of about 240 nH/Ω, and an SRF/length ratio of about 0.094 GHz/in.

14) The electronic component of claim 1, wherein the wire has a size within the range of 52-gauge to 56-gauge.

15) The electronic component of claim 18, wherein the component comprises at least one of hard and soft magnetic material.

16) A surface mountable inductive component comprising:
a miniature chip form having a main horizontal portion and enlarged ends extending therefrom, the horizontal portion having a smaller cross-section than the enlarged ends; and
a wire wound about at least a portion of the main horizontal portion of the chip form and having first and second ends connected to or forming respective terminals on each enlarged end for mounting the component to a circuit;
wherein the inductive component has a length to width ratio within the range of about 2.1 to about 2.5.

17) The inductive component of claim 16, wherein the component has a width less than about 0.014 in.

18) The inductive component of claim 16, wherein the component has an area less than about 0.00026 in².

19) The inductive component of claim 16, wherein the inductive component has a length to width ratio of about 2.4, a board area of about 0.00028 in², an SRF value of about 1.6 GHz, an inductance to DCR ratio of about 240 nH/Q, and an SRF/length ratio of about 0.094 GHz/in.

20) A method of forming an inductive component comprising:
providing a core having a reduced width portion and a length to width ratio within the range of about 2.1 to about 2.5,
winding wire around the reduced width portion of the core, the wire having first and second wire ends to form the electronic component, and
at least one of connecting the first and second wire ends to terminals and forming terminals from the first and second wire ends,
wherein the electronic component has a length to width ratio of about 2.4, a board area of about 0.00028 in², an SRF value of about 1.6 GHz, an inductance to DCR ratio of about 240 nH/Ω, and an SRF/length ratio of about 0.094 GHz/in.
